(19) United States
(12) Patent Application Publication
(10) Pub. No.: US 2019/0280633 A1
(43) Pub. Date: Sep. 12, 2019

(54) SYSTEMS AND METHODS FOR REDUCING CODE EXECUTION TIME IN MOTOR CONTROL SYSTEMS

(71) Applicant: GM GLOBAL TECHNOLOGY OPERATIONS LLC, Detroit, MI (US)

(72) Inventors: Kibok Lee, Ann Arbor, MI (US); Young Joo Lee, Rochester, MI (US); Brian Gallert, Royal Oak, MI (US)

(73) Assignee: GM GLOBAL TECHNOLOGY OPERATIONS LLC, Detroit, MI (US)

(21) Appl. No.: 15/914,460

(22) Filed: Mar. 7, 2018

(51) Int. Cl. H02P 23/00; G05B 15/02; B60L 15/20

(52) U.S. Cl. CPC H02P 23/0027; G05B 15/02; B60L 2240/421; B60L 15/20; B60L 2260/42; H02P 23/0077

(57) ABSTRACT

A method for reducing code execution time in motor controllers includes receiving a feedback signal from a motor component and transmitting a motor control signal to control the motor component based on first and second attributes of the motor component by iteratively alternating between two modes. In the first mode a first code execution segment is performed utilizing the feedback signal to determine a current value of a first attribute of the motor component, and a current value of a second attribute of the motor component is determined using a past value of the second attribute. In the second mode a second code execution segment is performed utilizing the feedback signal to determine a current value of the second attribute of the motor component, and a current value of the first attribute of the motor component is determined using a past value of the first attribute.

### TECHNICAL FIELD

The present disclosure generally relates to motor controllers, and more particularly relates to systems and methods for reducing code execution times in such motor controllers.

### BACKGROUND

Modern closed-loop motor controllers typically include a processor for executing software code designed to control (e.g., via a pulse-width modulation or “PWM” signal) the rotational position and speed of the motor. Typically, the execution of the software code—the collective duration of which is referred to as the “code execution time”—must take place during a predetermined time period, sometimes referred to as the “PWM period” or “PWM switching period.” This code execution time might encompass, for example, code for estimating the position and/or speed of the motor (referred to herein as “position and speed processing”) and/or code for current regulation (referred to herein as “current regulator processing”).

It will be apparent that it is desirable to reduce the amount of code execution time taking place within a given PWM switching period. Accomplishing this reduction is difficult however, as utilizing a higher performance processor (to speed up code execution) can lead to increased costs, while adjusting the PWM period can increase audible noise and/or lower motor control performance.

Accordingly, it is desirable to provide improved systems and methods for motor control with reduced code execution time. Furthermore, other desirable features and characteristics of the present invention will become apparent from the subsequent detailed description and the appended claims, taken in conjunction with the accompanying drawings and the foregoing technical field and background.

### SUMMARY

Systems and methods are provided for reducing code execution time in motor controller systems. In one embodiment, a method for motor control includes receiving a feedback signal from a motor component and transmitting a motor control signal to control the motor component based on first and second attributes of the motor component (e.g., motor position/speed, motor current, etc.) by iteratively alternating between two modes. In the first mode a first code execution segment is performed utilizing the feedback signal to determine a current value of a first attribute of the motor component (i.e., closed loop), and a current value of a second attribute of the motor component is determined using a past value of the second attribute (i.e., open loop). In the second mode a second code execution segment is performed utilizing the feedback signal to determine a current value of the second attribute of the motor component, and a current value of the first attribute of the motor component is determined using a past value of the first attribute.

In one embodiment, the first code execution segment corresponds to motor position and speed processing. In one embodiment, the second code execution segment corresponds to current regulator processing.

In one embodiment, the second attribute of the motor is motor current.

In one embodiment, the first attribute of the motor is motor position, a third attribute of the motor is motor speed, and the current value of the first attribute is set equal to a sum of the past value of the motor position and the product of the past value of the motor speed and a predetermined time interval.

In one embodiment, the method includes performing an analog-to-digital conversion of the feedback signal prior to transmitting the motor control signal.

In one embodiment, the motor control signal is a pulse-width modulation (PWM) signal.

A motor controller in accordance with one embodiment includes a processor configured to execute machine readable software instructions that, when executed by the processor, cause the processor to receive a feedback signal from a motor component communicatively coupled to the motor controller, wherein the feedback signal is responsive to one or more attributes of the motor. The motor controller further transmits a motor control signal to control the motor component based on first and second attributes of the motor component by iteratively alternating between two modes: a first mode in which a first code execution segment is performed utilizing the feedback signal to determine a current value of a first attribute of the motor, and a current value of a second attribute of the motor is determined using a past value of the second attribute, and a second mode in which a second code execution segment is performed utilizing the feedback signal to determine a current value of the second attribute of the motor, and a current value of the first attribute of the motor is determined using a past value of the first attribute.

In one embodiment, the first code execution segment corresponds to motor position and speed processing. In one embodiment, the second code execution segment corresponds to current regulator processing.

In one embodiment, the second attribute of the motor is motor current.

In one embodiment, the first attribute of the motor is motor position, a third attribute of the motor is motor speed, and the current value of the first attribute is set equal to a sum of the past value of the motor position and the product of the past value of the motor speed and a predetermined time interval.

In one embodiment, the method further includes performing an analog-to-digital conversion of the feedback signal prior to transmitting the motor control signal.

In one embodiment, the motor control signal is a pulse-width modulation (PWM) signal.

A moveable platform in accordance with one embodiment includes a motor component; a drive system mechanically coupled to the motor component; a motor controller communicatively coupled to the motor component, the motor controller configured to: receive a feedback signal from a motor component, the feedback signal responsive to one or more attributes of the motor; transmit a motor control signal to control the motor based on first and second attributes of the motor by iteratively alternating between two modes. In the first mode, a first code execution segment is performed utilizing the feedback signal to determine a current value of a first attribute of the motor, and a current value of a second attribute of the motor is determined using a past value of the second attribute. In the second mode, a second code execution segment is performed utilizing the feedback signal to determine a current value of the second attribute of the motor, and a current value of the first attribute of the motor is determined using a past value of the first attribute.

In one embodiment, the first code execution segment corresponds to motor position and speed processing. In one embodiment, the second code execution segment corresponds to current regulator processing.

In one embodiment, the motor controller further performs an analog-to-digital conversion of the feedback signal prior to transmitting the motor control signal.

In one embodiment, the motor control signal is a pulse-width modulation (PWM) signal.

In one embodiment, the drive system is selected from the group consisting of electric vehicle drive systems and electric bike drive systems.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an exemplary moveable platform with a motor control system in accordance with various embodiments;

FIG. 2 illustrates, conceptually, a code execution sequence in connection with a conventional motor control system;

FIG. 3 illustrates, conceptually, a code execution sequence in accordance with various embodiments; and

FIG. 4 is a flowchart illustrating a motor control method in accordance with various embodiments.

### DETAILED DESCRIPTION

Systems and methods are described for performing motor control using a reduced code execution time, thus preventing the potential cost increase resulting from using higher performance processors and/or the increased noise and reduced motor control performance caused by decreasing the motor control period—e.g., a pulse with modulation (PWM) period.

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely one exemplary embodiments of the present disclosure.

For the sake of brevity, conventional techniques related to motor controllers, PWM systems, drive systems, computer software, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

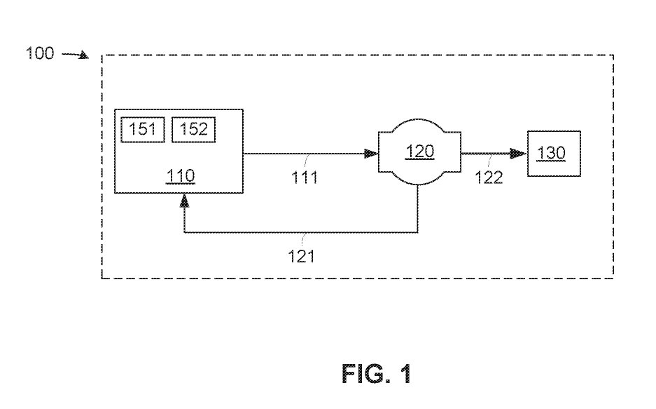

Referring now to FIG. 1, a moveable platform 100 in accordance with various embodiments generally includes a motor controller (or simply “controller”) 110 communicatively coupled (via a motor command signal 111 and a feedback loop 121) to a motor or other electrical machine 120, which itself is mechanically coupled to a suitable drive system 130 (e.g., a transmission, one or more wheels, etc.) configured to produce movement of moveable platform 100 relative to its environment.

Moveable platform 100 might correspond to any type of vehicle or device that incorporates an electrical motor or other electrical machine and which might benefit from the use of a motor controller system with reduced code execution time as described herein. Non-limiting examples of such moveable platforms include electric bikes, motorcycles, trucks, electric or hybrid vehicles (including autonomous vehicles), marine vessels, aircraft, robotic devices, and the like.

Motor controller 110 includes at least one processor 151 and a computer-readable storage device or media 152. The processor 151 may be any custom-made or commercially available processor, a central processing unit (CPU), a graphics processing unit (GPU), an auxiliary processor among several processors associated with the motor controller 110, a semiconductor-based microprocessor (in the form of a microchip or chip set), any combination thereof, or generally any device for executing code instructions. The computer readable storage device or media 152 may include volatile and nonvolatile storage in read-only memory (ROM), random-access memory (RAM), or the like. The computer-readable storage device or media 152 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the motor controller 110 in controlling the moveable platform 100.

The code instructions that are executed by processor 151 may include one or more separate programs, each of which comprises an ordered listing of executable instructions for implementing logical functions. The executable instructions may be implemented using any high or low-level computer language now known or later developed, for example, compiled c code, assembly language code, or the like. The instructions, when executed by the processor 151, receive and process signals from motor 120 (and potentially other subsystems, not illustrated), perform logic, calculations, methods and/or algorithms for automatically generating a control signal 111 (e.g., a PWM control signal) that is transmitted to motor 120 based on the logic, calculations, methods, and/or algorithms.

In some embodiments, motor command signal 111 comprises a PWM signal selected to control the rotational speed of motor 120. The range of embodiments is not so limiting, however. The nature of PWM signals are known in the art, and need not be described in detail herein. In general, the term “PWM” is used to refer to any control scheme in which the duty cycle of a train of on/off pulses is used to control the average voltage and/or current provided to motor 120, thereby controlling its rotational speed.

Motor 120 may be any type of brushed or brushless electrical motor now known or later developed. Motor controller 110 receives feedback from motor 120 in the form of a signal or signals 121. In one embodiment, signal 121 includes information regarding the rotational speed (ω) and the position (θ), of one or more components of motor 120. In other embodiments, fewer or more attributes of motor 120 are included within signal 121. A variety of sensors known in the art may be used in conjunction with motor 120 to provide feedback signal 121, including, for example, resolvers, optical or capacitive encoders, hall-effect devices, and the like.

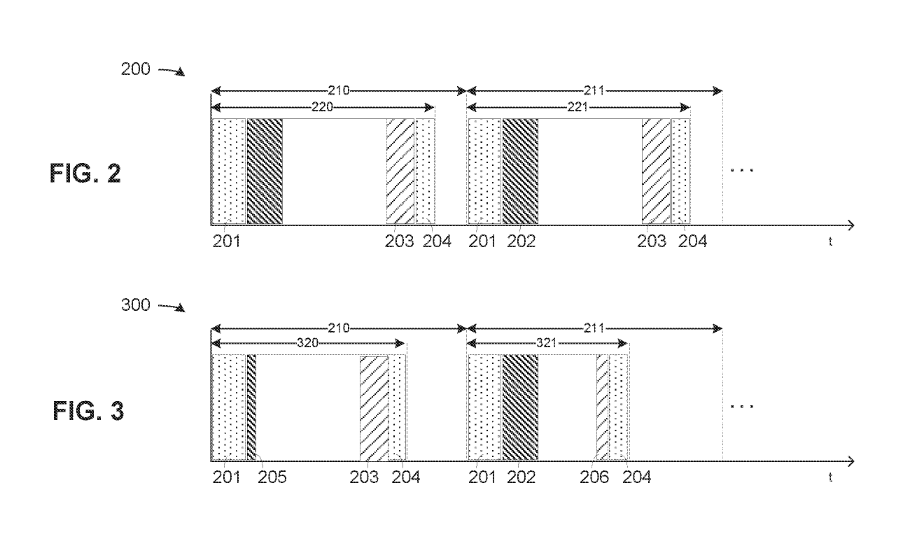

FIG. 2 illustrates, conceptually, a code execution sequence in connection with a conventional motor control system, and FIG. 3 illustrates, conceptually, a code execution sequence in accordance with various embodiments in which the code execution time has been reduced.

As mentioned briefly above, the execution of the software code by controller 110 takes place during a “code execution time” that necessarily fits within the PWM switching period.” In accordance with the illustrated embodiment, this code execution time encompasses the execution of code for estimating the position and/or speed of the motor based on feedback signal 121 (“position and speed processing”) and the execution of code for current regulation (“current regulator processing”). Position and speed processing includes, for example, extracting motor 120 position and speed from the measured raw motor currents and voltages, or measured raw position feedback signals from one or more encoders or resolver as known in the art.

Current regulator processing is performed in any suitable manner to produce motor terminal voltage values corresponding to the commanded motor current and/or the desired motor shaft torque (i.e. “direct torque control”). In general, the motor terminal voltages are computed based upon the measured and commanded currents.

Referring first to FIG. 2, which illustrates operation of a conventional motor control scheme, two consecutive PWM switching periods 210 and 211 are illustrated. Within each of these periods 210 and 211, the same sequence of code execution segments take place within code execution times 220 and 221, respectively. Namely, each of the code execution times 220 and 221 include a preprocessing of analog-to-digital conversion (ADC) segment 201, a position and speed processing segment 202, and a current regulator processing segment 203 that occurs after an intervening time interval in which other functions may be executed. Such functions might include, but are not limited to, protection functions and diagnostics of over-current, over-voltage, and/or over-speed between the position and speed processing and current regulator processing. This is followed by the actual PWM signal segment 204. It will be appreciated that the segments 202 and 203 might occur in a different order and/or at different times within their respective code execution times and may have a variety of relative durations. The conceptual sequences illustrated in FIGS. 2 and 3 are not meant to be limiting in any way.

As will be apparent in FIG. 2, the code execution times 220 and 221 are consistent in length and take up a substantial portion of their respective PWM switching times 210 and 211. Both of these segments can be considered “closed-loop” processes. In accordance with the present subject matter, however, the effective code execution time is reduced by performing the full regulator processing segment 202 only every other PWM period and similarly performing the full position and speed processing segment on every other, alternating, PWM period. During these periods, an “open loop” equivalent to these code execution segments is employed instead.

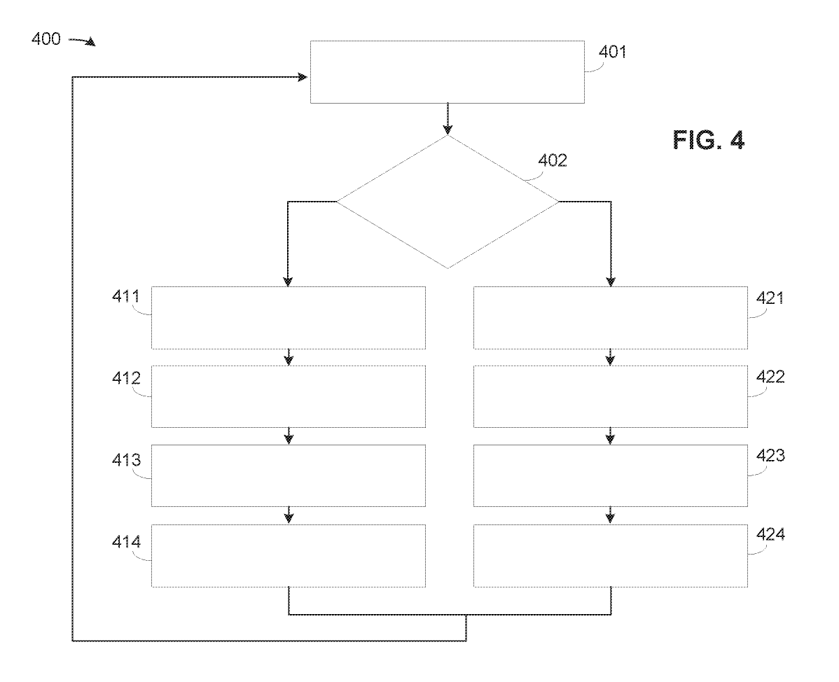

In this regard, FIG. 4 is a flowchart illustrating a motor control method 400 in accordance with various embodiments. More particularly, FIG. 4 illustrates the same two consecutive PWM switching periods 210 and 211. In contrast with FIG. 3, however, within each of these periods 210 and 211 a different sequence of code execution segments take place within code execution times 320 and 321, respectively.

That is, code execution time 320 includes open loop position and speed processing segment 202, but closed loop current regulator processing segment 205. Conversely, code execution time 321 includes open loop current regulator processing segment 203, but closed loop position and speed processing segment 206. Instead, as discussed in further detail below, during code execution time 320, new position and speed values are computed in open loop fashion based on speed and acceleration estimated in previous PWM period and is used in place of the value typically produced during closed loop current regulator processing segment 203. Similarly, during code execution time 321, the values of speed and position are computed in closed loop fashion based on the measured motor currents and voltages, or raw positions in current PWM period, and while the current regulator processing is in open loop fashion, which is much simpler than closed loop one. As will be appreciated from comparing FIG. 3 to FIG. 2, code execution time 320 is significantly shorter than code execution time 220, and code execution time 321 (which is not necessarily the same duration as code execution time 320) is also significantly shorter than code execution time 221. This savings in code execution time increases the “margin” provided by the code execution times within a given PWM period and has been found to have no significant deleterious effects on motor control.

Referring now to the flowchart illustrated in FIG. 4 in conjunction with FIGS. 1-3, an exemplary motor control method 400 will now be described. Initially, at 401, preprocessing of analog-to-digital (herein, ADC) conversion takes place with respect to feedback signal 121. The preprocessing of the ADC signal is performed to convert the measured raw feedback signals (e.g., motor currents and voltages, or motor position in the form of ADC integer count numbers) into real units such as amps, volts and radians. The converted feedback quantities in real unit are used for the speed and position processing as well as current regulator processing.

In addition, it is assumed that a state of the motor controller 110 is stored such that the system can determine whether it performed, during a previous PWM period, a given (closed loop) code execution segment, or whether it performed the alternate (open loop) estimate. In the present example, this is accomplished by storing the state of two flags, which will be referred to herein as a “speed estimation flag” and a “current regulator flag.” During any cycle of the loop shown in FIG. 4, if a flag is a logical False, it means that the corresponding code execution segment was not performed during the previous PWM period (i.e., the previous loop of procedure 400). If a flag is a logical True, however, it means that the corresponding code execution was performed during the previous PWM period.

With that in mind, the method continues to 402, in which the system is queried as to whether the first code execution segment flag is False, and the second code execution segment is True. In the present example, the first code execution segment will be associated with position and speed processing, and the second code execution segment will be associated with current regulator processing. The invention is not so limited, however.

If the query at 402 returns a True, then processing continues with steps 411-414 and then loops back to step 401. If the query at 402 returns a False, then processing continues with steps 421-424 before looping back to step 401.

With respect to 411, the system (i.e., motor controller 110) first runs a full, closed loop version of the position and speed processing code (e.g., segment 202 in FIG. 3). This results in an estimate of the speed and position of motor 120. Subsequently, at 412, other functions are performed by motor controller 110, examples of which are given above. Next, at 413 the current regulator value is updated with a previous value (open loop), i.e., the value produced during the previous PWM period. Stated another way, if this value is referred to as Vdq[k] for any particular PWM period k, then the value used during step 413 is given by Vdq[k−1]. Finally, at 414, the values of the flags are each inverted. That is, in the instant example, the speed estimation flag is set to True, and the current regulation flag is set to False.

Referring now to the “False” branch from step 402, beginning with step 421, the system updates the position and speed estimation open loop based on the previous values, i.e., the values determined during the previous PWM period. In one embodiment, the motor position is estimated as being equal to the previous motor position multiplied by the previous angular velocity. Stated another way, if the position and velocity of motor 120 is given, for any iteration k, as θ[k] and w[k] respectively, then the values assigned at step 421 are as follows: θ[k]=θ[k−1]+w[k−1]T, and w[k]=w[k−1], where T is the time elapsed between iterations (e.g., the PWM period 210).

Next, at 422, one or more “other” functions are executed, as discussed previously. Subsequently, at 423, the full, closed-loop current regulator processing is performed (e.g., segment 203 in FIG. 3). Finally, at 424, the values of the flags are each inverted. That is, in the instant example, the speed estimation flag is set to False, and the current regulation flag is set to True. Processing then loops back to 401, whereupon ADC conversion is once again performed.

It will be appreciated that the logic of method 400 results in a motor control scheme in which, for each code execution segment, that segment alternates between being performed closed loop (i.e., utilizing feedback signal 121 from motor 120) and being performed open loop (i.e., utilizing only state information from a prior iteration). This results in a reduced code execution time, thus preventing the potential cost increase resulting from using higher performance processors and/or the increased noise and reduced motor control performance caused by decreasing the motor control period.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for motor control, comprising:
receiving a feedback signal from a motor component, the feedback signal responsive to one or more attributes of the motor;
transmitting a motor control signal to control the motor component based on first and second attributes of the motor component by iteratively alternating between two modes:
a first mode in which a first code execution segment is performed utilizing the feedback signal to determine a current value of a first attribute of the motor component, and a current value of a second attribute of the motor component is determined using a past value of the second attribute, and
a second mode in which a second code execution segment is performed utilizing the feedback signal to determine a current value of the second attribute of the motor component, and a current value of the first attribute of the motor component is determined using a past value of the first attribute.

2. The method of claim 1, wherein the first code execution segment corresponds to motor position and speed processing.

3. The method of claim 2, wherein the second code execution segment corresponds to current regulator processing.

4. The method of claim 3, wherein the second attribute of the motor is motor current.

5. The method of claim 3, wherein the first attribute of the motor is motor position, a third attribute of the motor is motor speed, and the current value of the first attribute is set equal to a sum of the past value of the motor position and the product of the past value of the motor speed and a predetermined time interval.

6. The method of claim 1, further including performing an analog-to-digital conversion of the feedback signal prior to transmitting the motor control signal.

7. The method of claim 1, wherein the motor control signal is a pulse-width modulation (PWM) signal.

8. A motor controller comprising:
a processor configured to execute machine readable software instructions that, when executed by the processor, cause the processor to:
receive a feedback signal from a motor component communicatively coupled to the motor controller, the feedback signal responsive to one or more attributes of the motor;
transmit a motor control signal to control the motor component based on first and second attributes of the motor component by iteratively alternating between two modes:
a first mode in which a first code execution segment is performed utilizing the feedback signal to determine a current value of a first attribute of the motor, and a current value of a second attribute of the motor is determined using a past value of the second attribute, and
a second mode in which a second code execution segment is performed utilizing the feedback signal to determine a current value of the second attribute of the motor, and a current value of the first attribute of the motor is determined using a past value of the first attribute.

9. The motor controller of claim 1, wherein the first code execution segment corresponds to motor position and speed processing.

10. The motor controller of claim 2, wherein the second code execution segment corresponds to current regulator processing.

11. The motor controller of claim 3, wherein the second attribute of the motor is motor current.

12. The motor controller of claim 3, wherein the first attribute of the motor is motor position, a third attribute of the motor is motor speed, and the current value of the first attribute is set equal to a sum of the past value of the motor position and the product of the past value of the motor speed and a predetermined time interval.

13. The motor controller of claim 1, further including performing an analog-to-digital conversion of the feedback signal prior to transmitting the motor control signal.

14. The motor controller of claim 1, wherein the motor control signal is a pulse-width modulation (PWM) signal.

15. A moveable platform comprising:
a motor component;
a drive system mechanically coupled to the motor component;
a motor controller communicatively coupled to the motor component, the motor controller configured to:
receive a feedback signal from a motor component, the feedback signal responsive to one or more attributes of the motor;
transmit a motor control signal to control the motor based on first and second attributes of the motor by iteratively alternating between two modes:
a first mode in which a first code execution segment is performed utilizing the feedback signal to determine a current value of a first attribute of the motor, and a current value of a second attribute of the motor is determined using a past value of the second attribute, and
a second mode in which a second code execution segment is performed utilizing the feedback signal to determine a current value of the second attribute of the motor, and a current value of the first attribute of the motor is determined using a past value of the first attribute.

16. The moveable platform of claim 15, wherein the first code execution segment corresponds to motor position and speed processing.

17. The moveable platform of claim 15, wherein the second code execution segment corresponds to current regulator processing.

18. The moveable platform of claim 15, wherein the motor controller further performs an analog-to-digital conversion of the feedback signal prior to transmitting the motor control signal.

19. The moveable platform of claim 15, wherein the motor control signal is a pulse-width modulation (PWM) signal.

20. The moveable platform of claim 15, wherein the drive system is selected from the group consisting of electric vehicle drive systems and electric bike drive systems.
